(19) United States
(12) Patent Application Publication
(10) Pub. No.: US 2025/0057356 A1
(43) Pub. Date: Feb. 20, 2025

(54) BEVERAGE OR FOODSTUFF PREPARATION SYSTEM

(71) Applicant: SOCIETE DES PRODUITS NESTLE S.A., Vevey (CH)

(72) Inventors: ALAIN TEKLITS, Corsier (CH); FLORENT LEFEBVRE-PAUTIGNY, Publier (FR); ANTOINE JOLY, Metabief (FR); MICHAL PIVRNEC, Boussens (CH)

(21) Appl. No.: 18/721,465

(22) PCT Filed: Dec. 20, 2022
(86) PCT No.: PCT/EP2022/086931

§ 371 Date: Jun. 18, 2024

(30) Foreign Application Priority Data
Dec. 22, 2021 (EP) 21216914.8
Dec. 22, 2021 (EP) 21216916.3

(51) Int. Cl. A47J 31/44; A47J 31/40; A47J 31/52; B65D 85/804

(52) U.S. Cl. CPC A47J 31/4492; A47J 31/407; A47J 31/52; B65D 85/8058

(57) ABSTRACT

A system comprising: a container for containing precursor material, the container comprising a machine readable code, and; a machine for preparing a beverage or a foodstuff by processing said precursor material, the machine comprising: a code reading system to read said code; a processing unit for processing the precursor material of the container to the beverage or foodstuff; electronic memory storing a plurality of predefined recipes for controlling the processing unit; a user interface, and; electrical circuitry configured to control the processing unit to process the container based on a recipe stored in association with information encoded by the code, wherein the electrical circuitry is configured to select one of said recipes from the plurality of recipes based on both information encoded by the code and an input from the user interface.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine to define a recipe, and; the recipe is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

Various codes have been developed, an example of which is provided in EP 2594171 A1, wherein a lower side of a flange of a capsule comprises a code arranged thereon. A drawback of such a code is that its encoding density is limited, i.e. the amount of preparation information that it can encode is limited.

Such a drawback is increasingly significant as recipes become increasingly complex, particularly as they may be implemented to derive multi-component beverages, which, for example, to produce require the control of separate processing systems for coffee and milk components.

Therefore, in spite of the effort already invested in the development of said systems further improvements are desirable.

### SUMMARY

The present disclosure provides a system comprising: a container for containing precursor material, the container comprising a machine readable code, and; a machine for preparing a beverage or a foodstuff by processing said precursor material, the machine comprising: a code reading system to read said code; a processing unit for processing the precursor material of the container to the beverage or foodstuff; electronic memory storing a plurality of predefined (e.g. different) recipes for controlling the processing unit (e.g. with the processing unit controlled to execute a preparation process in which the container is processed); a user interface, and; electrical circuitry configured to control the processing unit (e.g. to execute the preparation process) to process the container based on a recipe (e.g. one only of said plurality of recipes) stored in association with information encoded by the code, wherein the electrical circuitry is configured to select one of said recipes based on both information encoded by the code and an input from the user interface. In embodiments, each recipe comprises a set (e.g. a full so that no more parameters are required or partial set) of fixed value parameters that are required as input by the processing unit for the preparation process. In embodiments, each of the recipes are stored in association with information encoded by a code, (e.g. so that a different code is linked to each recipe).

By implementing a plurality of recipes on a database of the machine and having a shortlist of these plurality of recipes defined by the code (e.g. the shortlist may comprise recipes for different types of beverage that the container is suitable for preparing, such as 1 recipe for a late, 1 recipe for an espresso, 1 recipe for a cappuccino etc.), the code can be read to define the short list and then the particular recipe from the short list can be selected by a user via a user interface input (e.g. by a selection of the type of beverage, rather than individual parameters of the recipe). With such an implementation, the range of possible recipes linked to the code may be expanded when compared to a single recipe associated with the code.

In embodiments, for each recipe, the parameters of a recipe are stored as a set of fixed values on the electronic memory. The fixed values may be pre-installed on the electronic memory, and/or only adjustable via an software update. In embodiments, the set of parameters of the recipe are not individually accessible/adjustable by an input from the user interface (said input may be the input to select a recipe). Rather, only a recipe may be selectable. In embodiments, the recipe represented on the user interface for selection as an indication, which is representative of the recipe, e.g. an icon that is indicative of a beverage type that is associated with the recipe.

In embodiments, the information encoded by the code to select one of said recipes is arranged as a recipe identifier that (e.g. in a first mode of operation of the system) is associated with one or more recipes (but not all the recipes) of the plurality of recipes stored on the electronic memory. By implementing the machine to operate using a recipe identifier on the code in a first mode, a recipe may be conveniently looked-up from a repository of recipes on a database of the machine.

In embodiments, the electronic memory is arranged to store recipes for a plurality of different beverage or foodstuff types, wherein each type comprises one or more of said recipes for preparing said type, and the recipe identifier is associated with a single recipe from each type, and the input from the user interface comprise a selection of a type.

As used herein the term “type” in respect of a beverage or foodstuff may refer to a specific subsets within a beverage or foodstuff classification. For example, the classification is coffee, and the type may comprises types of coffee, e.g. one or more of: cappuccino; late; flat white; latte macchiato; espresso; other like type. For example, the classification is tea, and the type comprises types of tea, e.g. one or more of: chai; late; black tea; other like type.

By implementing the code to be associated with a single recipe for each type, the container may be processed according to specifically adapted recipes for a range of types, hence expanding its operability. That is, when operating in the first mode, the code comprises a recipe identifier that is associated with a plurality of recipes for the different types of beverage of foodstuff, wherein the recipe is selected from said plurality of recipes based on the input from the user interface.

In embodiments, the electrical circuitry is configured to store the input from the user interface of the type selection (e.g. on electronic memory) if received before determining the recipe identifier from the code (e.g. before the code is read and/or processed to extract the identifier), and to subsequent to obtaining the recipe identifier, implement selection of the single recipe based on the recipe identifier and the stored type. By storing the type selection made by a user until the single recipes of each type can be determined by the recipe identifier, a user can make a type selection at any time before reading of the code. The system may thereby be more convenient for the user to operate.

In embodiments, the electrical circuitry is configured to determine the identifier and to, subsequent to determination of the identifier (e.g. and the single recipes of each type from the identifier), prompt the user via the user interface to input the type selection, and implement selection of the single recipe based on the recipe identifier and a received input type from the user interface. With such an arrangement the user may be conveniently guided though a process by which the beverage is prepared.

As used herein the term “prompt” may refer to any notification, e.g. audible or visual, to the user via a user interface to indicate an input is required. It may include a user interface highlighting elements (e.g. buttons or portions of a display) that indicate which types of the plurality of types of beverage that are available. In embodiments, not all types are available with every code, for example out of the types: cappuccino; late; flat white; latte macchiato; espresso, espresso may not be available for particular codes.

In embodiments, the recipe identifier is used in a second mode of operation of the system to encode a value of at least one parameter (e.g. a volume of a component of the beverage) of a recipe directly on the container (i.e. the code thereof). By implementing the identifier to directly encode a parameter in the second mode, and as well as being used to look-up a recipe in the first mode, the code may have a high information density/storage efficiency. Moreover, the first mode may be used for suitable containers to implement enhanced functionality, whereas the second mode may be used in a conventional or legacy mode for other containers without disruption of the code by incorporation the first mode.

In embodiments, the beverage or foodstuff prepared by the processing unit of the machine in the second mode comprises a first component only. By implementing the second mode as a relatively simplistic mode (e.g. a first component that is coffee based only, rather than with an additional milk component), the machine may be used in a conventional or legacy mode for particular containers.

As used herein the term “component” in respect of a beverage or foodstuff may refer to an output from a single processing unit. Hence for systems that include a first component processing unit and a second component processing unit, the beverage or foodstuff may comprise a first and second component. And for systems that include only a first component processing unit, the beverage or foodstuff may comprise only a first component.

In embodiments, the beverage or foodstuff prepared by the machine comprises a first component and a second component, and the recipe is for controlling the processing unit to prepare at least the first component. By implementing the recipe to prepare at least the first component, the first mode may precisely control individual components of a beverage with increased functionality over the second mode.

In embodiments, the recipe is configured to include the provision of instructions (e.g. the recipes selection triggers the electrical circuitry to send the instruction) to a user interface of the system to prepare the second component. By providing instructions (e.g. an audible or a written or other notification) on a user interface (e.g. the user interface may be of the machine or the peripheral device or other electronic device of the system) for machines that do not comprise a second component processing unit (or have a second component processing unit but do not integrate such a unit in a control system of the machine), the user may be instructed how to manually integrate such a second component processing unit with a preparation process.

In embodiments, the processing unit is a first component processing unit for processing the first component of the beverage or foodstuff, and the system comprises at least one second component processing unit for processing the second component of the beverage or foodstuff, and the electrical circuitry is configured to control the one or more second component processing unit to prepare the second component, and the recipe or instructions (in the case of manual control) are for controlling the second component processing unit to prepare the second component.

By implementing the recipe to control both the first and second component processing units, both first and second components of a beverage may be precisely controlled to provide complex beverages with multiple different components that can be provided by different processes. For example, in embodiments, the first component processing unit is arranged to process the precursor material of the container and second component processing unit is arranged to condition a fluid component (e.g. milk) of the beverage or foodstuff.

In embodiments, the first component processing unit is arranged to process the precursor material of the container and second component processing unit is arranged to condition a fluid component of the beverage or foodstuff.

In embodiments, the recipe for controlling the first component processing unit to prepare at least the first component comprises one or more of the following: volume of the first component; fluid temperature; fluid flow rate; operational parameters of the processing unit (e.g. rpm for a centrifugal extraction unit); order of dispensing (e.g. before or after the second component); any of the aforesaid defined for one or more phases.

In embodiments, the recipe for controlling the second component processing unit to prepare the second component comprises one or more of the following: volume of the second component;

fluid temperature; fluid flow rate; operational parameters of the processing unit; order of dispensing (e.g. before or after the first component); agitation; any of the aforesaid defined for one or more phases.

In embodiments, the code includes a mode identifier and the electrical circuitry is arranged to select one of the following modes of operation based on a stored relationship between the identifier and the modes (e.g. the identifier is a key and is associated with one of the following mode selections in a key-value database storage paradigm):
a first mode, in which the electrical circuitry is configured to select one of said recipes based on said both information encoded by the code and an input from the user interface;
a second mode in which at least part of the recipe is encoded directly on the code, and the processing unit is controlled based on the at least part of the recipe encoded directly on the code;
optionally a third mode in which a default recipe stored on the electronic memory is used or in which a preparation process is prevented and an error message may be provided to a user via a user interface.

By having a mode identifier stored by the code, before any more complex processing steps associated with one of the modes is implemented, the mode identifier may be used to determine the mode of operation of the machine.

In embodiments, the mode identifier is used in the second mode of operation of the system to encode a value of at least one parameter of a recipe directly on the code. By implementing the mode identifier to directly encode a parameter in the second mode, and as well as being used to look-up a mode of operation, the code may have a high information density/storage efficiency, without disruption of the code when used in the second mode.

The present disclosure provides a system comprising: a container for containing precursor material, the container comprising a machine readable code, and; a machine for preparing a beverage or a foodstuff by processing said precursor material, the machine comprising: a code reading system to read said code; a processing unit for processing the material of the container to the beverage or foodstuff; electronic memory storing a plurality of recipes, and; electrical circuitry to control the processing unit to process the container (e.g. to execute a preparation process, in which the container is processed), electrical circuitry configured to operate in a first mode (in which a first type of preparation process is executed) wherein a recipe identifier of the code is associated with a recipe (e.g. one recipe) of a plurality of said recipes, and the processing unit is controlled based on said recipe, the electrical circuitry to operate in a second mode (in which an alternative second type of preparation process is executed), wherein at a value of at least one parameter of a recipe (i.e. an alternative recipe, that can be fully or partially encoded by the code) is encoded directly on the code, and the processing unit is controlled based on the said value.

By implementing the machine to operate using a recipe identifier on the code in a first mode, a recipe can be looked-up from a repository of recipes on a database of the machine, and by implementing the machine to operate in a second mode where a parameter (or all parameters) of a recipe is fully or partially encoded directly in the code, the functionality of the code may be expanded. For example, enhance functionality provided by additional recipes may be provided for machines additionally operable in the first mode, whereas machines operable in only the second mode may implement a single custom recipe encoded on the code. Particularly, the recipes in the first mode may be updated, e.g. via a communication interface of the machine.

In embodiments, in the second mode the recipe identifier is not used to look up a recipe that is used in the first type of preparation process. In embodiments, in the first mode the at least one parameter encoded directly in the code (that is used in the second mode), is not used to control the processing unit.

In embodiments, the electrical circuitry is configured to operate in the first mode or second mode based on a mode identifier (e.g. the mode identifier is separate to the recipe identifier) and a stored relationship between the mode identifier and said modes of operation.

By implementing a mode identifier encoded by the code to be recognisable by the machine to determine if the machine can operated with the particular capsule in the first mode (and/or the second mode), the machine may conveniently identify the modes of operation of a container.

Code reading of the container may be initiated by an instruction from a user interface (e.g. by pressing of a start button). When the machine is operable in only one of the modes with the container (e.g. the second mode), then said mode may be automatically executed after the code is read.

When the machine is operable in both of the modes with the container, then said mode may be selected by an instruction from a user interface (e.g. by pressing of a start button once or twice to distinguish between the two modes). A type selection (as will be discussed) may also designate selection of the first mode.

In embodiments, the recipe identifier and/or mode identifier is used in the second mode of operation of the system to directly encode the value of the at least one parameter of a recipe on the container, which is used to control the processing unit.

By implementing the identifier also to be arranged to encode a value of a parameter of a recipe on the container, the code may have a high information density since a separate parameter from the direct encoding is not required.

The present disclosure provides a machine for preparing a beverage or a foodstuff by processing said precursor material of a container, the machine comprising: a code reading system to read a code of the container; a processing unit for processing the precursor material of the container to the beverage or foodstuff; electronic memory storing a plurality of recipes; a user interface, and; electrical circuitry configured to control the processing unit to process the container based on a recipe stored in association with information encoded by the code, wherein the electrical circuitry is configured to select said recipe based on both information encoded by the code and an input from the user interface.

The present disclosure provides a machine for preparing a beverage or a foodstuff by processing said precursor material of a container, the machine comprising: a code reading system to read a code of the container; a processing unit for processing the material of the container to the beverage or foodstuff; electronic memory storing a plurality of recipes, and; electrical circuitry to control the processing unit to process the container, the electrical circuitry configured to operate in a first mode wherein a recipe identifier of the code is associated with a recipe (e.g. one recipe) of a plurality of said recipes, and the processing unit is controlled based on said recipe, the electrical circuitry to operate in a second mode, wherein a value of at least one parameter of a recipe (i.e. an alternative recipe, that can be fully or partially encoded by the code) is encoded directly on the container, and the processing unit is controlled based on the said value.

The present disclosure provide use of a container comprising the machine readable code for the system of any of any preceding embodiment or another embodiment disclosed herein.

The present disclosure provides a method of preparing a beverage or a foodstuff.

In embodiments, the method comprises selecting a recipe from electronic memory based on information encoded by a code of a container and an input from the user interface, and; preparing said beverage or foodstuff based on said recipe. The method may implement the features of any pre preceding embodiment or another embodiment disclosed herein. The recipe may consists of a set of fixed value parameters that are required as input by a processing unit for the preparation process. The recipe may consists of a set of fixed value parameters that are required as input by a processing unit for the preparation process.

In embodiments, the method comprises reading a code of a container and selectively operating in first and/or second modes, the first mode comprising reading a recipe identifier from code and controlling a machine to prepare said beverage or foodstuff based on a recipe associated with the identifier, the second mode (which is executed instead of the first mode) comprising controlling the machine to prepare said beverage or foodstuff based on at least one parameter of a recipe which is directly encoded on the container. The method may implement the features of any pre preceding embodiment or another embodiment disclosed herein.

The present disclosure provides electrical circuitry to implement (e.g. by of control a machine for preparing a beverage or a foodstuff, which may be of any preceding embodiment or another embodiment disclosed herein) the method of the preceding embodiment or another embodiment disclosed herein.

The present disclosure provides a computer readable medium comprising program code (which may include instructions to control a machine for preparing a beverage or a foodstuff which may be of any preceding embodiment or another embodiment disclosed herein) to implement the method of the preceding embodiment or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B and 5 are illustrative diagrams showing an embodiment container processing system of the machine of FIG. 2.

FIG. 6 is an illustrative diagram showing embodiment machine and beverage of the system of FIG. 1.

FIG. 7 is a block diagram showing embodiment control electrical circuitry of the machine of FIG. 2.

FIG. 8 is an illustrative diagram showing embodiment container of the system of FIG. 1.

FIG. 9 is flow diagram showing an embodiment preparation process, which is performed by the system of FIG. 1.

FIG. 10 is a plan view showing a code of the container of FIG. 8.

FIG. 11 is a flow diagram showing an embodiment process for determining a recipe that is used in the preparation process of FIG. 9.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a closing member, e.g. a membrane, for closing the container. The container may have various forms, including one or more of: frustoconical; cylindrical; disk; hemispherical; packet; other like form. The container may be formed from various materials, such as metal or plastic or a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot and may be potable. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder, powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to a change in a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material. The processing unit may have any suitable implementation, including a container processing unit or a loose material processing unit.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; an external device, and; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to a storage medium that encodes preparation information. The code may be an optically readable code, e.g. a bar code. The code may be arranged as a bit code (e.g. a binary sequence of 0s and 1s encoded by the absence or presence of an element). The code may be formed of a plurality of units, which can be referred to as elements or markers. The elements may implement a finder portion and a data portion, wherein the finder portion encodes a predefined reserved string of bits that is identifiable when processing the code from the data portion, to enable location of the data portion, which encodes the preparation information. The code may be arranged as a one dimensional code, which is read by relative movement between the code and a code reader. The code reader may provide a bit stream signal or a high and low signal for processing by preparation information extraction. It will be understood that a code may therefore exclude a mere surface finish or branding on a container, which is not configured in any way for information storage.

As used herein the term “preparation information” may refer to one of more of: parameters as defined herein; a recipe as defined herein; an identifier, and; other information related to the operation of the machine.

As used herein, the term “parameter” may refer to a variable that is used as an input for controlling (e.g. RPM) and/or or a property of the beverage/foodstuff or a precursor thereof that is controlled by the processing unit (e.g. a fluid target temperature or volume) during the preparation process. Depending on the implementation of the processing unit said parameter may vary. Examples include: volume of a particular component of the beverage and/or foodstuff (e.g. controlled by a pump of a fluid condition system); fluid temperature (e.g. controlled by a heat exchanger of a fluid condition system); fluid flow rate (e.g. controlled by a pump of a fluid condition system); operational parameters of the processing unit, e.g. RPM of an extraction unit based on centrifugation or closing force for a hydraulic brewing unit; an order of dispensing of components of the beverage and/or foodstuff; agitation (e.g. frothing degree); any one or more of the aforesaid defined for one or more phases, wherein the preparation process is composed of a series of sequential, discrete phases; a time duration of applying any one or more of the aforesaid parameters, including a time of a phase. The parameter may have a value, which may be numerical and can vary in predetermined increments between predetermined limits, e.g. a temperature of the water may vary between 60-90 degrees in 5 degree increments.

As used herein, the term “recipe” or “control data set” may refer to a combination of said parameters, e.g. as a full or partial set of inputs, that are used by the processing unit to prepare a particular beverage and/or food stuff.

As used therein, the term “identifier” may refer to a unique sequence of bits that forms a key of a key-value database paradigm. Specifically a single identifier may relate to one or a predefined number of recipes which are stored on the electrical circuitry of the system. An identifier may be considered different to parameters that are encoded directly on the container, since the identifier does not encode a single parameter, instead it is linked by the key-value database paradigm a full of partial set that is the recipe.

As used herein the term “directly” or “direct” in respect of a value of a parameter encoded by the code, may refer to the parameter having a number of possible values that encode a magnitude of the associated parameter, with one of which being directly extractable from the code, rather than extractable along with a series of other parameters via an identifier and a look-up table. Alternatively put, it may refer to the encoding of a value that can vary independently of the other parameters of the recipe on code. For example, four bits may encode 1-16 magnitudes of water temperature with 1 being the lowest and 16 being the highest, these magnitudes may be scaled by a rule on the machine to provide an actual temperature used in the preparation process.

As used herein, the term “preparation process” may refer to a process to prepare a beverage or foodstuff from a precursor material or to prepare a pre-precursor material from precursor material. A preparation process may refer to the processes electrical circuitry executes to control the processing unit to process said precursor or pre-precursor material.

As used herein, the term “code reading process” may refer to the process of reading the code to extract the preparation information (which can include the identifier and/or parameters). The process may include one or more of the following steps: obtaining a digital image of the code or a code signal; extracting a sequence of bits from the code; identifying a finder portion of the code in the sequence; locating a data portion using the finder portion, and; extracting the preparation information from the data portion.

### [General System Description]

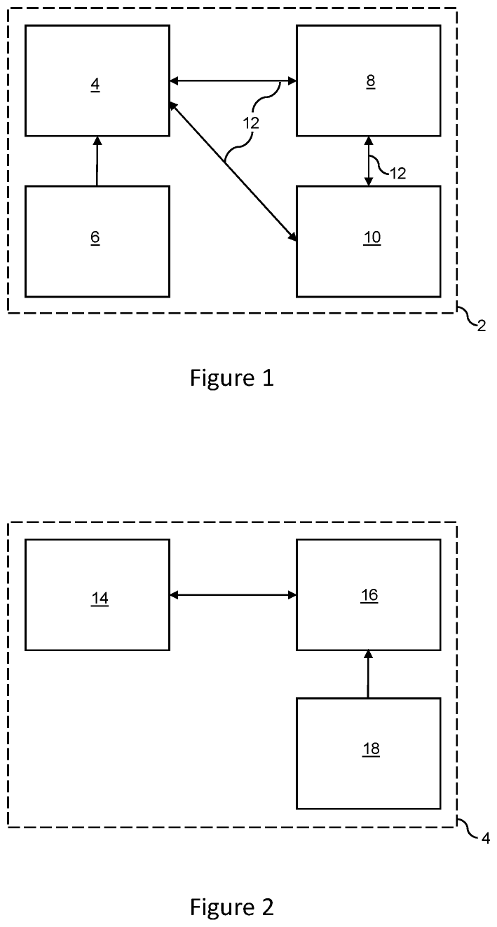

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### [First Example of Processing Unit]

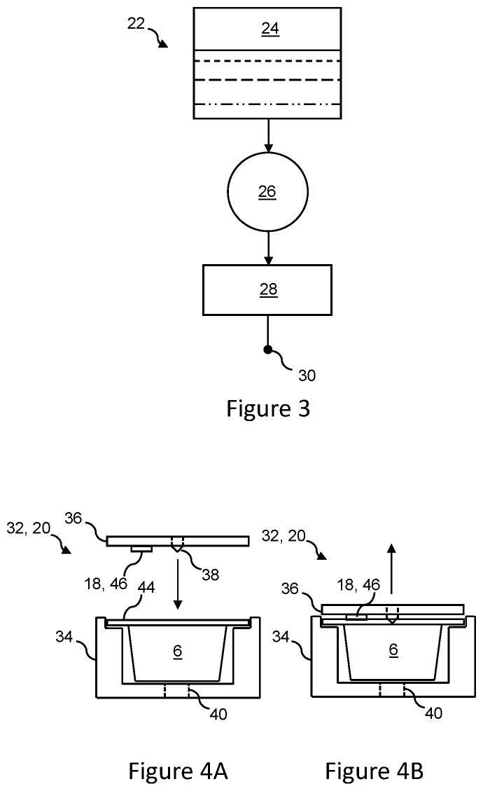

Referring to FIGS. 2 and 3, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### [Fluid Conditioning System]

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1-6 below:

Referring to FIGS. 4A and 4B, a first example of the container processing unit 20 is for processing of a container arranged as a capsule 6 (a suitable example of a capsule is provided in FIG. 8, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4A), in which capsule holding portion 34 and a closing portion 36 are arrange to receive a capsule 6. The extraction unit 32 is movable to a capsule extraction position (FIG. 4B), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 to inject the conditioned fluid into the capsule 6 in the capsule extraction position, typically under high pressure. A beverage outlet 40 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIG. 4A, 4B) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the closing portion and capsule holding portion, they may be alternatively arranged, including: the injection head and beverage outlet are arranged respectively on the capsule holding portion and closing portion; or both on the same portion. Moreover, the extraction unit may include both parts arranged as a capsule holding portion, e.g. for capsules that are symmetrical about the flange, including a Nespresso® Professional capsule.

Examples of suitable extraction units are provided in EP 1472156 A1 and in EP 1784344 A1, which are incorporated herein by reference, and provide a hydraulically sealed extraction unit.

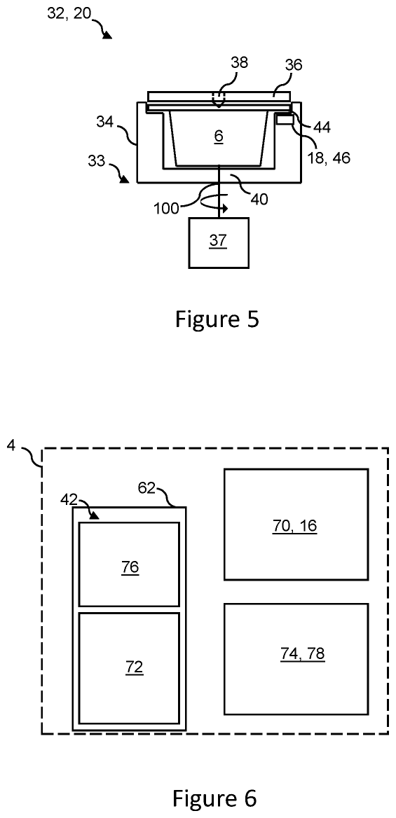

Referring to FIG. 5, in a second example of the container processing unit 20, the extraction unit 32 is as described for the first example, however the extraction unit 32 operates at a lower fluidic pressure and by centrifugation. In particular, the extraction unit 32 includes a rotation mechanism 33 that includes a capsule holing portion 34 to hold the capsule 6 and a drive system 37 to rotate said capsule holder 35.

The outlet 30 of the fluid conditioning system 22 is arranged as on the closing portion 36 as an injection head 38 to inject the conditioned fluid into a centre of the capsule 6 through a closing member of the capsule 6 as will be discussed. The rotation mechanism 33 rotates the capsule to effect transmission of the conditioned fluid radially outwards through precursor material in the capsule 6 and out through peripheral arranged puncture points (not illustrated) in the closing member. An example of a suitable capsule is a Nespresso® Vertuo capsule. A suitable example is provided in EP 2594171 A1, which is incorporated herein by reference.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a containment portion of the capsule. An example of a suitable capsule is a Nespresso® Dolce Gusto capsule. Examples of suitable extraction units are disclosed in EP 1472156 A1 and in EP 1784344 A1, which are incorporated herein by reference.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle.

### [Code Reading System]

Referring to FIGS. 4A and 4B, the code reading system 18 is arranged to read a code 44 arranged on a closing member of the container 6. The code reading system 18 is integrated with the extraction unit 32 of first example of the container processing unit 20. The code 44 is read with the extraction unit 32 in the capsule extraction position (as shown in FIG. 4B).

The code reading system 18 includes an image capturing unit 46 to capture a digital image of the code 44. Examples of a suitable image capturing unit 46 include a Sonix SN9S102; Snap Sensor S2 imager; an oversampled binary image sensor; other like system.

The electrical circuitry 16 includes image processing circuitry (not illustrated) to identify the code in the digital image and extract preparation information. An example of the image processing circuitry is a Texas Instruments TMS320C5517 processor running a code processing program.

Referring to FIG. 5, the code reading system 18 is alternatively arranged to read a code 44 from an underside of a flange of the container 6. The code 44 is read based on rotation of the code 44 relative a code reader 46 of the code reading system 18. The code 44 is read with the extraction unit 32 in the capsule extraction position (as shown in FIG. 5), with the rotation mechanism 33 rotating the container 6.

The code reading system 18 includes a code reader 46 to capture a code signal of the code 44. Examples of a suitable image code reader 46 include a photo diode or other electrical componentry that can distinguish between dark and light elements of the code. In variant embodiments, which are not illustrated, the code reader can be implemented as the image capturing unit, as discussed above, or with another suitable reading system.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is alternatively implemented, e.g. the code reading system is arranged on the machine to read a code of a container that a user manually presents to the image capturing device. In further variant embodiments, which are not illustrated, the code reading system is arranged to read a code at a different location of the container, e.g. on a storage portion.

### [Component Processing Unit Machine Configuration]

Referring to FIG. 6, the machine 4 is arranged in a first example with a first component processing unit 70 that incorporates the processing unit 14 as described in the previous examples. The first component processing unit 70 is arranged to prepare, as part of the preparation process, a first component 72 of the beverage and/or foodstuff 42.

In the first example, the machine 4 is further arranged with a second component processing unit 74 for processing the second component 76 of the beverage or foodstuff 42. The first component processing unit 70 is arranged to process the precursor material of the container 6. The second component processing unit 74 is arranged to condition a fluid component of the beverage or foodstuff that is separate from the container.

The first component processing unit 70 and second component processing unit 74 may eject the associated first and second components 72, 76 of the beverage and/or foodstuff through the same outlet (not illustrated) or via dedicated separate outlets (not illustrated) to a receptacle 62 for consumption.

In a specific embodiment of the first example of the machine 4, the first component processing unit 70 comprises a processing unit 14 arranged as an extraction unit 32, e.g. the second example of the extraction unit 32 as shown in FIG. 5 which operates based on centrifugation. The extraction unit 32 is specifically configured to provide a first component that is coffee based.

The second component processing unit 74 comprises a processing unit 78 to provide the second component 76 of the beverage 42, that is milk based. In a first example, the second component processing unit 74 implements a fluid conditioning system as described for the processing unit 14, which is operable to provide conditioned (e.g. heated) fluid as the second component 76. In a second example, the second component processing unit 74 implements a fluid conditioning system (not illustrated) that is operable to provide conditioned (e.g. heated and/or agitated, including aerated/froth) fluid as the second component 76. Examples of suitable fluid conditioning systems include the De′Longhi™ milk system, as implemented on Nespresso™ machines including the Lattissima™ or the milk system as implemented on the Nespresso™ Aeroccino™. In variant embodiments, the second component processing unit 74 is alternatively implemented, including as a dissolution unit as previously described.

The first component processing unit 70 and second component processing unit 74 of the machine 4 are both controlled by common electrical circuitry 16 as part of the preparation process as will be discussed. The first component processing unit 70 and second component processing unit 74 are implemented on a common body. In variant embodiments, which are not illustrated, they are implemented as separated units that are communicatively coupled by the communication interface.

In a second example, which is not illustrated, of the machine 4, the arrangement is as discussed for the first example, however the second component processing unit 74 is independently controlled, for example, it is controlled by separate electrical circuitry that is not in communication with the electrical circuitry 16. In this example the second component processing unit 74 can be a stand alone machine or integrated with the machine 4. Moreover, second component processing unit 74 can be manually operated (e.g. a user manually sets one or more of: agitation degree; temperature; volume; other quantity) or can be fully automated (e.g. a user provides an instruction to prepare a particular second component and this is prepared).

### [Control Electrical Circuitry]

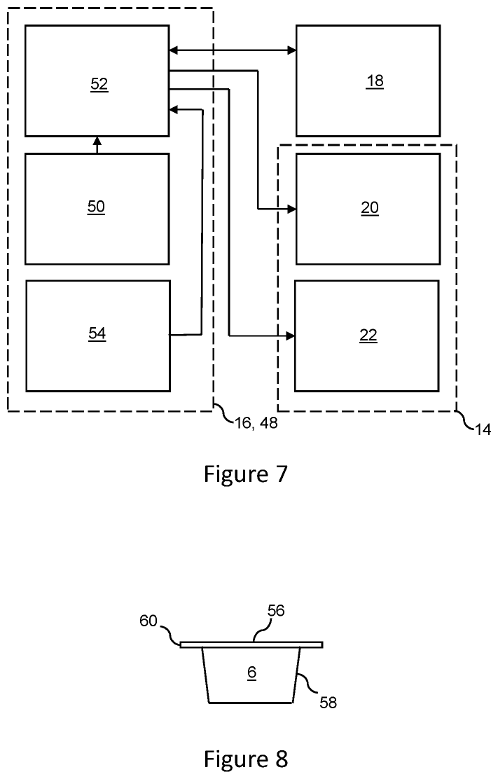

Referring to FIG. 7, the electrical circuitry 16 is implemented as control electrical circuitry 48 to control the processing unit 14 to execute a preparation process (and optionally a processing unit of the second component processing system when present). In the embodiment of FIG. 7, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 46 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule.

### [Container]

Referring to FIG. 8, an example of a container 6, that is for use with the first example or second example of the processing unit 14 comprises the container 6 arranged as a capsule. The capsule includes: a closing member 56; a storage portion 58, and; a flange portion 60.

The storage portion 58 includes a cavity for storage of the precursor material (not illustrated). The closing member 56 closes the storage portion 58 and comprises a flexible membrane. The flange portion 60 is arranged integrally with the storage portion 58 and presents a flat surface for connecting the closing member 56 to the storage portion 58 to hermetically seal the precursor material. The capsule 6 has a diameter of 2-5 cm and an axial length of 2-4 cm.

In variant embodiments, which are not illustrated, the container can have various shapes including: hemispherical; curved; rectangular in section; frustoconical, and; other like shapes. The closing member may be arranged as a rigid member, rather than a membrane. The container may be formed of two similar or identical storage portions that are connected at a flange, hence the closing member can me omitted. The closing member may connect to the storage portion, hence the flange may be omitted.

Suitable examples of containers and/or closing members in terms of shapes, dimensions and/or materials are know from any of the cartridges, capsules and pods for portioned flavouring ingredients used by Nespresso™ (Original Line, Professional Line, Vertuo Line) and Nestle Dolce Gusto™ and Nestle Special-T™. The materials may thus include metal, for instance aluminium, plastic and/or paper. The materials are preferably biodegradable and/or recyclable. Suitable use, e.g. extraction, processes and systems are also known from Nespresso™, Nestle Dolce Gusto™ or Nestle Special-T™.

Constructional, manufacturing and/or (beverage) extraction details of containers and/or closing members are for instance disclosed in EP 2155021, EP 2316310, EP 2152608, EP2378932, EP2470053, EP2509473, EP2667757 and EP 2528485.

### [Arrangement of Code]

Referring to FIG. 5, the code 44 code is arranged on an exterior surface of the container 6 in any suitable position such that it can be read by the code reading system 18. Referring to FIG. 8, the code 44 (not illustrated in FIG. 8) may be arranged on one or more of the following positions: the closing member 56; a lower surface of the flange portion 60 that faces away from the closing member 56; the storage portion 58.

### [Process for Preparing a Beverage]

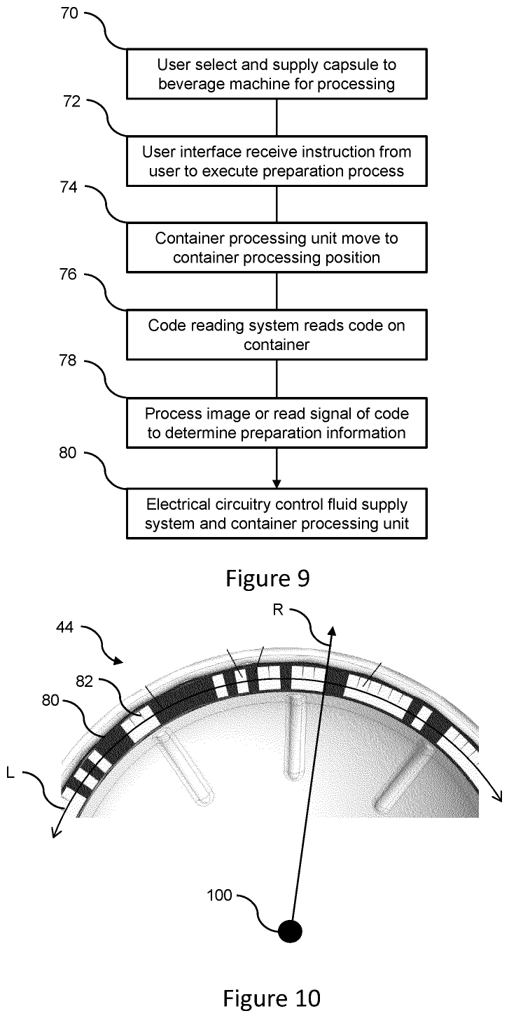

Referring to FIG. 9, the execution of a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first or second example of the container processing unit 20, the extraction unit 32 is moved from the capsule receiving position (FIG. 4A) to the capsule extraction position (FIG. 4B, FIG. 5).

Block 76: the electrical circuitry 16 controls the code reading system 18 to read the code 44 on the container 6 and provide a digital image of the code or a code signal related to the code.

Block 78: the code processing circuitry of the electrical circuitry 16 processes the digital image to or code signal extract the preparation information and determine a recipe of parameters.

Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction position though the capsule ejection position to eject the container 6 and back to the capsule receiving position.

In variant embodiments, which are not illustrated: the above blocks can be executed in a different order, e.g. block 72 before block 70 or block 76 before block 74 or block 76 before block 72 (e.g. the container is detected as being present, by the code reading system or a dedicated sensor, and is read automatically without a user input and user input may follow to confirm execution of the preparation process); some block can be omitted, e.g. where a machine stores a magazine of capsules block 70 can be omitted; alternatively at blocks 70 to 76 a user presents the code of the container to the code reading system and after it is read opens said container and dispenses the pre-precursor material into the processing unit. Moreover, the container processing unit may be manually moved between the extraction position and capsule receiving position.

Blocks 76 and 78 may be referred to a code reading process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

For machines that implement a second component processing system 74, said system can be controlled to prepare the second component 76 of the beverage and/or foodstuff in parallel or before or after the first component 72 that is prepared by the processing unit 14 of the first component processing system 70.

### [Code General Description]

Referring to FIG. 10, the code 44 is formed of a plurality of elements 80. The elements 80 are arranged on a surround 82. The elements 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 or code reader 46 to distinguish therebetween. In variant embodiments, which are not illustrated: the elements are a light colour and the surround is a dark colour.

The elements 80 are formed by printing e.g. by means of an ink printer. As an example of printing the ink may be conventional printer ink and the substrate may be the container outer surface including one of the closing member, flange or storage portion, or a separate substrate, which is connected to the container. In variant embodiments, which are not illustrated, the elements are alternatively formed, including by embossing, engraving or other suitable means.

The elements 80 are arranged to be read sequentially when the container is rotated about an axis of rotation 100 (as also illustrated in FIG. 5). The elements 80 of the code 44 are arranged on a circumferentially extending virtual line L, which is spaced radially in a radial direction R from a rotational axis 100.

### [Code General Encoding]

The elements 80 encode a data portion for storing the preparation information, and encode a finder sequence for locating the data portion. The elements 80 are encoded as a bit code, wherein the absence or presence of an element encodes a logical 1 or a 0.

The finder sequence (not illustrate) comprises a predefined reserved sequence of logical 1s and/or 0s, which is identifiable when processing the code. The data sequence is arranged at a known position with respect to the finder sequence, e.g. immediately after or distributed within the finder sequence. Hence with the finder sequence located, the data sequence can then be located read and decoded. The data sequence may be decoded based on a rule stored on the electrical circuitry 16 (e.g. via electronic memory) of the machine 2. A specific example of such a code is provide in EP 2594171 A1.

### [Code Based First and Second Mode of Operation]

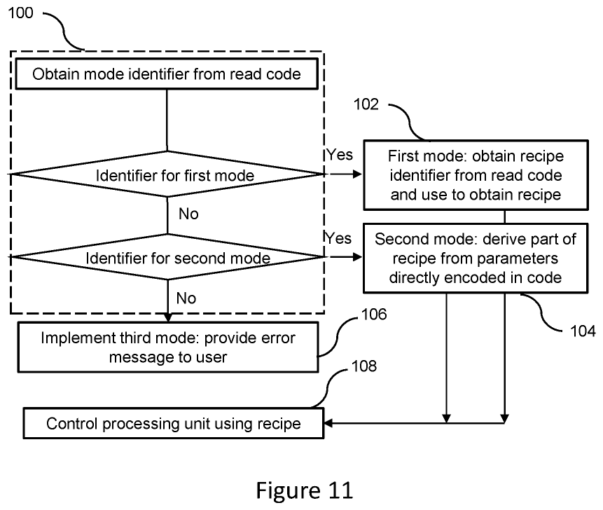

Referring to FIG. 11, the electrical circuitry 16 of the system 2 implements the following sub-process, which can be implemented as part of block 78 and block 80 of the process previously described in association with FIG. 9:

Block 100: obtain mode identifier from code and determine operating mode based on identifier (e.g. electronic memory of the electrical circuitry 16 stores a list of known mode identifiers and for each mode identifier there is an assigned operating mode, this database can be arranged as a as a key-value data storage paradigm).

Block 102: if the mode identifier is assigned to a first mode, then the machine 4 is operated in a first mode, and a separate recipe identifier is read from the code. A recipe is selected from a plurality of recipes stored on electronic memory based on the recipe identifier (e.g. electronic memory of the electrical circuitry 16 stores a list of known recipe identifiers and for each recipe identifier there is an assigned recipe, this database can be arranged as a as a key-value data storage paradigm).

Block 104: if the mode identifier is assigned to a second mode, then the machine 4 is operated in a second mode. In the second mode a value of at least one parameter of a recipe is encoded directly on the code 44, whereby this value is read directly from the code 44. The recipe in the second mode is therefore different to the recipe of the first mode since some or all parameters in the data set that comprises the recipe are directly encoded by the code 44.

Block 106: if the mode identifier is assigned to a third mode, then the machine 4 is operated in a third mode. The third mode comprises a condition where the container associated with the code is not suitable for use in the first or second modes. It may comprise providing an error message to a user via the user interface of the input unit 50.

Block 108: the processing unit 14 is controlled using the recipe determined by the first or second modes.

In variant embodiments, which are not illustrated: block 106 may be omitted; in the first mode, the mode identifier may be used to determine the recipe instead of a dedicated recipe identifier, e.g. they may refer to the same item, or the mode identifier may be used in combination with the recipe identifier to determine the recipe; in the second mode, all the parameters used as input for the processing unit (e.g. the full recipe) may be encoded directly by the code or some, e.g. at least one, parameters may be encoded directly by the code with others being determined by an identifier (e.g. the mode identifier or a dedicated identifier), which is used to retrieve the remaining parameters from the electronic memory of the electrical circuitry, as a key-value data storage paradigm; instead of implementing a mode identifier the user may manually switch between the modes, e.g. via the user interface of the input unit 50; the third mode may also be implemented for the condition where the code 44 could not be read, and; the third mode may comprise or using a default recipe to prepare the beverage/foodstuff.

The recipe identifier from the first mode is also used in the second mode to directly encode the value one or more parameters.

In a first example, when operating in the second mode, the parameter encoded is temperature of a first component of the beverage or foodstuff. The temperature is encoded as a number of magnitudes of 1-N, where N can be any suitable value depending on the required number of temperature settings. In the example where N=4, the encoding is via two bits of the data portion of the code. In the example where N=16, the encoding is via four bits of the data portion of the code.

When operating in the first mode, the electronic memory that comprises a plurality of recipes, each of which being associated with a recipe identifier, is structured so that the magnitudes of the temperature are also used as a recipe identifier.

In other examples other parameters are encoded, including: volume or flow rate of the first component, and; operational parameters of the processing unit, e.g. RPM of a centrifugally operated extraction unit of the second example of the container processing unit.

In this way the portion of the code that is used in the second mode is re-used in the first mode. Hence the code has a high information density. Moreover, for machines that operate only in the first mode (e.g. a legacy mode), the code is unchanged, but for machines that are able to operate additionally in the first mode additional functionality is provide.

In a similar manner, the mode identifier can also be used in the second mode to directly encode the value one or more parameters.

In variant embodiments, which are not illustrated, a dedicated portion of the code can be used for the mode identifier and/or recipe identifier, which is separate to that used for the direct encoding of the second mode.

Referring back to FIG. 11, at block 102 for the first mode, the electronic memory that comprises a plurality of recipes, each of which being associated with a recipe identifier, is structured so that in addition to the recipe identifier being used to select a recipe from said plurality, a user input from the user interface of the input unit 50 is also used to select said recipe.

This is achieved by implement the recipe identifier to be associated with more than one recipe from the plurality of recipes of the electronic memory. In this way the recipe identifier is used to define a short list of several recipes from the plurality of recipes (where the short list comprises less recipes than that of said plurality of recipes of the electronic memory), with a user input being used to select a single recipe from the shortlist.

Referring to table 1 below, as an example of this implementation, the electronic memory is arranged to store a plurality of recipes, which are categorised into a plurality of different beverage or foodstuff types, that are exemplified as: espresso; cappuccino, and; late macchiato.

There are 100-108 recipes that represent the plurality of recipes stored on the electronic memory. There are three recipes per type, i.e. type espresso has recipes 100, 101 and 102. There are three different recipe identifiers, with one unique identifier per type, i.e. recipe identifier 100, is used for one espresso recipe 100, one cappuccino recipe 103 and one late macchiato recipe 106. Hence, for a recipe identifier determine in the code 44 as 100, the short list of recipes would comprise recipe 100, 103, 106. The user input from the user interface selects the type from this short list, so for example if a cappuccino is selected then recipe 103 is selected and is used in the preparation process.

TABLE 1
Recipe Identifier and Type related to recipe

| Recipe Identifier | Type | Recipe |
|---|---|---|
| 100 | Espresso | 100 |
| 101 | Espresso | 101 |
| 102 | Espresso | 102 |
| 100 | Cappuccino | 103 |
| 101 | Cappuccino | 104 |
| 102 | Cappuccino | 105 |
| 100 | late macchiato | 106 |
| 101 | late macchiato | 107 |
| 102 | late macchiato | 108 |

In embodiments, if the user inputs on the user interface of the input unit 50 the type prior to the code reading system 18 reading the code 44 (and obtaining the shortlist), then the electrical circuitry 16 of the system 2 is configured to store the type selection on electronic memory (not illustrated). Once the code 44 has been read (and the short list of recipes for each type determined) then the stored type used to select the single recipe from the short list. Such a series of operation may occur if the machine is powered up and a user enters the type selection on the user interface prior to providing a container 6 to the machine 4, or if a type selection is entered during the code reading process.

In embodiments, the electrical circuitry 16 is configured to read the code 44, extract the identifier and determine the short list of recipes for each type, and if a type selection has not been entered then the electrical circuitry 16 sends a prompt to the user interface of the input unit 50 to request selection of the type. Said prompt may for example include highlighting elements (e.g. buttons on an display or keys that a user presses) of the user interface for types that are available for the particular container (in such an example, depending on the code associated with the container not all types may be available). Once the type selection is made then the single recipe is selected from the shortlist.

In embodiments, in the event that the type section is entered before the shortlist is determined, and subsequent to the determination of the shortlist it is determined that the selected type is not available for the container, then the user may be prompted to selected a type as discussed above.

In variant embodiments, which are not illustrated, there is no user input such that a single recipe identifier is associated with a single recipe; there are other numbers of types, e.g. 2, 4 or more; there are other numbers of recipes per type, e.g. 2, 4 or more; there are other numbers pf recipe identifiers.

Referring back to FIG. 6, and the first example of the machine 4, that includes: the first component processing unit 70 that incorporates the processing unit 14 for processing the first component 72 of the beverage or foodstuff 42, and; the second component processing unit 74 for processing the second component 76 of the beverage or foodstuff 42.

With said machine 4, in the first mode, in one example, the recipe controls both the first component processing unit 70, and the second component processing unit 74 to provide the respective first 72 and second 76 components of the beverage 42. With such an example the recipe encodes parameters for both the first and second component processing units.

Where the first component processing unit 70 is an extraction unit to provide a first component 72 based on coffee, the parameters are one or more of: volume of the first component; fluid temperature; fluid flow rate; operational parameters of the processing unit (e.g. rpm for a centrifugal extraction unit); order of dispensing (e.g. before or after the second component); any of the aforesaid defined for one or more phases, and; other parameters.

Where the second component processing unit 74 is a milk processing unit to provide a second component 76 based on milk, the parameters are one or more of: volume of the second component; fluid temperature; fluid flow rate; operational parameters of the processing unit; order of dispensing (e.g. before or after the first component); agitation; any of the aforesaid defined for one or more phases, and; other parameters.

On such a machine 4 operating in the first mode, a recipe that comprises only coffee may also be executed, e.g. for proving an optimised espresso. Such a recipe comprises parameters only for controlling the first component processing unit 70.

In the second example of the machine 4 that includes the second component processing unit 74 as independently controlled, for example, it is controlled by separate electrical circuitry that is not in communication with the electrical circuitry 16. With said machine 4, in the first mode, in one example, the recipe controls the first component processing unit 70, but not the second component processing unit 74.

Instead, if the selected recipe requires the operation of the second component processing unit 74, said selection triggers the provision of instructions to a user interface of the input unit 50 (or other user interface of the system 2) to instruct a user on how to manually control the second component processing unit 74 to prepare the second component 76 in accordance with the recipe.

For example, the instructions may comprise the manual setting or preparing of one or more of: volume of the second component; fluid temperature; fluid flow rate; operational parameters of the processing unit; order of dispensing (e.g. before or after the first component); agitation; any of the aforesaid defined for one or more phases, and; other parameters. The instructions can be stored on the electronic memory in association with the recipe. In other embodiments, no instructions are provided.

In the above examples of the machine 4, when operating in the second mode only, the first component processing unit 70 is controlled. Hence the recipe that is at least partially encoded by the code 44 does not also require encoding of parameters for the second component processing unit 74. The second mode may therefore be considered a more simplified mode of operation with less functionality than the first mode and can be implemented on a machine with only a first component processing unit 70.

It will be understood that a machine 4 that only implements the second mode of operation can execute block 104 directly, and hence the second mode without determining a mode identifier thus obviating block 100 and block 102. And since the mode identifier and/or recipe identifier as used in the first mode can be integrated in the data portion of the code that is used for encoding the parameter(s) of the recipe of the second mode, the implementation of the first mode on suitable machines does not disrupt the operation of the second mode on such a machine.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
4 Machine
14 Processing unit
20 Container processing unit (first/second example)
32 Extraction unit
34 Capsule holding portion
36 Closing portion
38 Injection head
40 Beverage outlet
33 Rotation mechanism
37 Drive system
22 Fluid conditioning system
28 Heat exchanger
30 Outlet
16 Electrical circuitry
48 Control electrical circuitry
50 Input unit
52 Processor
54 Feedback system
18 Code reading system
46 Image capturing unit
6 Container (Capsule)
56 Closing member
58 Storage portion
60 Flange portion
44 Code
80 Elements
82 Primary Element
84 Secondary element
L Virtual line
82 Surround
100 Axis
R Radial direction
8 Server system
10 Peripheral device
12 Computer network

1. A system comprising:
a container for containing precursor material, the container comprising a machine readable code, and;
a machine for preparing a beverage or a potable foodstuff by processing said precursor material, the machine comprising:
a code reading system to read said code;
a processing unit for processing the precursor material of the container to the beverage or foodstuff;
electronic memory storing a plurality of predefined recipes for controlling the processing unit to execute a preparation process in which the container is processed, wherein each recipe comprises a set of fixed value parameters that are required as input by the processing unit for the preparation process;
a user interface, and;
electrical circuitry configured to control the processing unit to execute a preparation process based on one of said recipes selected from said recipes,
wherein said recipes are stored in association with information encoded by the code,
an the electrical circuitry is configured to select one of said recipes from the plurality of recipes based on both information encoded by the code and an input from the user interface.

2. The system of claim 1, wherein said parameters of the recipe are not individually adjustable by the user input.

3. The system of claim 1, wherein the information encoded by the code to select one of said recipes is arranged as a recipe identifier,
the electronic memory is arranged to store recipes for a plurality of different beverage or foodstuff types, wherein each type comprises one or more of said recipes for preparing said type,
and the recipe identifier is associated with a single recipe from each type, and
the input from the user interface comprise a selection of a type.

4. The system of claim 3, wherein the electrical circuitry is configured to:
store the input from the user interface of the type selection if received before determining the recipe identifier from the code, and to subsequent to obtaining the recipe identifier, implement selection of the single recipe based on the recipe identifier and the stored type and
determine the identifier and to, subsequent to determination of the identifier, prompt the user via the user interface to input the type selection, and implement selection of the single recipe based on the recipe identifier and said type.

5. The system of claim 2, wherein the recipe identifier is used in a second mode of operation of the system to encode a value of a parameter of a recipe directly on the code.

6. The system of claim 5, wherein the beverage or foodstuff prepared by the processing unit of the machine in the second mode comprises a first component only.

7. The system of claim 1, wherein the beverage or foodstuff prepared by the machine comprises a first component and a second component,
and the recipe is for controlling the processing unit to prepare the first component.

8. The system of claim 7, where the recipe is configured to include the provision of instructions to a user interface of the system to prepare the second component.

9. The system of claim 7, wherein the processing unit is a first component processing unit for processing the first component of the beverage or foodstuff,
the system comprises a second component processing unit for processing the second component of the beverage or foodstuff,
the electrical circuitry is configured to control the second component processing unit to prepare the second component, and
the recipe or instructions are for controlling the second component processing unit to prepare the second component.

10. The system of claim 9, wherein:
the recipe for controlling the first component processing unit to prepare at least the first component is selected from the group consisting of: volume of the first component; fluid temperature; fluid flow rate; operational parameters of the processing unit; order of dispensing; any of the aforesaid defined for one or more phases; and;
the recipe for controlling the second component processing unit to prepare the second component is selected from the group consisting of: volume of the second component; fluid temperature; fluid flow rate; operational parameters of the processing unit; order of dispensing; agitation; any of the aforesaid defined for one or more phases.

11. The system of claim 1, wherein code includes a mode identifier and the electrical circuitry is arranged to select one of the following modes of operation based on a stored relationship between the identifier and the modes:
a first mode, in which the electrical circuitry is configured to select one of said recipes based on said both information encoded by the code and an input from the user interface;
a second mode in which at least part of the recipe is encoded directly on the code, and the processing unit is controlled based on the at least part of the recipe encoded directly on the code;
a third mode in which a default recipe stored on the electronic memory is used or an error message is provided to a user interface.

12. A machine for preparing a beverage or a foodstuff by processing said precursor material of a container, the machine comprising:
a code reading system to read a code of the container;
a processing unit for processing the precursor material of the container to the beverage or foodstuff;
electronic memory storing a plurality of predefined recipes for controlling the processing unit to execute a preparation process in which the container is processed, wherein each recipe comprises a set of fixed value parameters that are required as input by the processing unit for the preparation process;
a user interface, and;
electrical circuitry configured to control the processing unit to execute a preparation process based on one of said recipes selected from said recipes,
wherein said recipes are stored in association with information encoded by the code, and
the electrical circuitry is configured to select one of said recipes from the plurality of recipes based on both information encoded by the code and an input from the user interface.

13. (canceled)

14. A method of preparing a beverage or a foodstuff, the method comprising:
selecting a recipe, which consists of a set of fixed value parameters that are required as input by a processing unit for the preparation process, from electronic memory based on information encoded by a code of a container comprising precursor material and an input from the user interface, and;
preparing said beverage or foodstuff based on said recipe.

15. (canceled)
